(19) United States
(12) Patent Application Publication
(10) Pub. No.: US 2014/0270300 A1
(43) Pub. Date: Sep. 18, 2014

(54) Hearing Aid Delivery and Retrieval Platform

(71) Applicants: Florent Michel, Annemasse (FR); Raphael Michel, Palo Alto, CA (US); Daniel Shen, Stanford, CA (US)

(72) Inventors: Florent Michel, Annemasse (FR); Raphael Michel, Palo Alto, CA (US); Daniel Shen, Stanford, CA (US)

(21) Appl. No.: 14/291,483

(22) Filed: May 30, 2014

Related U.S. Application Data
(63) Continuation of application No. 13/774,416, filed on Feb. 22, 2013.

(51) Int. Cl. H04R 25/00

(52) U.S. Cl. CPC H04R 25/00
USPC 381/329

(57) ABSTRACT

An apparatus for insertion, positioning and removal of an in-ear-canal hearing aid, comprising a resilient handle, an elongated support member configured to fit into an ear canal, the support member having a first end that is configured to engage the handle and a second end that includes magnetic engagement means configured to removably engage an in-ear-canal hearing aid, and an ear canal ingression stop that is configured to limit travel of the support member and, thereby, the in-ear-canal hearing aid when engaged thereto in the ear canal.

### CROSS-REFERENCES TO RELATED APPLICATIONS

This application is continuation-in-part of U.S. application Ser. No. 13/774,416, filed on Feb. 22, 2013, which claims the benefit of U.S. application Ser. No. 61/ 634,201, filed on Feb. 25, 2012.

### FIELD OF THE INVENTION

The present invention relates to devices that facilitate the placement or insertion of hearing aid devices into the ear. More particularly, the invention relates apparatus and systems that are adapted to place deep-in-the-canal hearing aids deeply in the ear canal, properly align the hearing aids in the ear canal, and remove the hearing aids from the ear canal, and still more particularly, the invention relates to placement apparatus and systems that can be used by the hearing aid wearer or by a second person assisting the wearer.

### BACKGROUND OF THE INVENTION

Hearing aids and prostheses that reside deep in the canal (i.e. deep-in-ear-canal devices or “DIEC” hearing aids), such as the open ear canal hearing prosthesis disclosed in Applicants' Co-Pending U.S. application Ser. No. 12/841,120, represent a major step forward in the development of hearing aids from several perspectives. The sound quality of in-ear-canal hearing prostheses is very high, they are effectively invisible from an external perspective, and they can reside in place for a period of several months; the residence time limit determined, in major part, by the lifetime of the battery.

As is well known in the art, DIEC hearing aids differ from completely-in-ear-canal hearing aids (“CIEC” hearing aids). CIEC hearing aids are typically larger than DIEC hearing aids and reside in the outer cartilaginous portion of the ear canal. CIEC hearing aids are also typically placed in the ear and easily removed by the wearer (by virtue of the larger size) on a daily basis.

In contrast, DIEC hearing aids are placed deep in the ear canal, in the bony portion of the canal very near the tympanic membrane. As indicated, the sound quality of MEC hearing aids is very high and they are effectively invisible from an external perspective.

A drawback of most conventional DIEC hearing aids is, however, that presently they must be inserted by a health care professional or by an individual trained to insert such devices by a health care professional. Insertion of DIEC hearing aids by a healthcare professional is necessitated by several factors, including the difficulty in handling such a small device without an instrument, the vulnerability of the hearing aids to breakage with mishandling, the impracticality of handling conventional insertion instruments without visual guidance, and the importance of not placing the hearing aid too deeply in the ear canal.

It would thus be desirable to provide a placement apparatus for DIEC hearing aids that facilitates proper placement of DIEC hearing aids in a wearer's ear canal.

It is therefore an object of the present invention to provide a placement apparatus for DIEC hearing aids that facilitates proper placement of DIEC hearing aids in a wearer's ear canal.

It is another object of the present invention to provide a placement apparatus for DIEC hearing aids that facilitates proper ear canal placement of DIEC hearing aids by the wearer and, hence, without the need for placement by a health care professional.

It is another object of the present invention to provide a placement apparatus for DIEC hearing aids that facilitates safe insertion of DIEC hearing aids in an ear canal, proper ear canal placement and removal of DIEC hearing aids by the wearer and, hence, without the need for placement by a health care professional.

### SUMMARY OF THE INVENTION

The present invention is directed to a placement apparatus for DIEC hearing aids that facilitates safe insertion of DIEC hearing aids in an ear canal, and proper ear canal placement and removal of DIEC hearing aids by the wearer and, hence, without the need for placement by a health care professional.

In one embodiment of the invention, the hearing aid placement apparatus comprises: (i) a resilient and compliable handle, (ii) an elongated support member that is configured to fit into an ear canal, the support member having a first end that is configured to engage the handle and a second end that includes magnetic means configured to removably engage an in-ear-canal hearing aid, and (iii) an ear canal ingression stop that is configured to limit travel of the support member and, thereby, an in-ear-canal hearing aid when engaged thereto in the ear canal.

In some embodiments, the magnetic means is configured to actuate a hearing aid on-off switch, wherein when the second magnetic end of the support member is engaged to the first end of said hearing aid, the hearing aid on-off switch transitions to an off position, whereby, no power from the hearing aid power source is transmitted to the hearing aid, and when the second magnetic end of the support member is disengaged from the first end of the hearing aid, the hearing aid on-off switch transitions to an on position, whereby, power from the hearing aid power source is transmitted to the hearing aid.

In some embodiments, the support member further includes memory means programmed and configured for storing programming signals for a hearing aid and an interior portion configured to receive the memory means.

In some embodiments, the support member further includes signal transmission means for transmitting the programming signals from the memory means to the hearing aid when the second magnetic end of the support member is engaged to the hearing aid.

In a preferred embodiment, the ear canal ingression stop is moveable along the longitudinal axis of the support member.

In some embodiments, the support member includes stop locking means that is configured to lock the ear canal ingression stop at a first predetermined longitudinal position on said support member.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is an illustration of a human ear structure;

FIG. 2 is a side plan view of one embodiment of a in-ear hearing aid placement apparatus, in accordance with the invention;

FIG. 3 is a side plan view of the hearing aid placement apparatus shown in FIG. 2 being employed to place a hearing aid in a wearer's ear canal, in accordance with the invention; and

FIG. 4 is a side plan, partial sectional view of another embodiment of a in-ear hearing aid placement apparatus, in accordance with the invention.

### DETAILED DESCRIPTION OF THE PREFERRED EMBODIMENT

Before describing the present invention in detail, it is to be understood that this invention is not limited to particularly exemplified apparatus, systems, structures or methods as such may, of course, vary. Thus, although a number of apparatus, systems and methods similar or equivalent to those described herein can be used in the practice of the present invention, the preferred apparatus, systems, structures and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise. Thus, for example, reference to “a telemetry communication” includes two or more such communications and the like.

### Definitions

The terms “hearing aid” and “hearing prosthesis” are used interchangeably herein and mean and include any device or system that is adapted to amplify and/or modulate and/or improve and/or augment sound or acoustic signals transmitted to (or for) a subject.

The following disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is understood that various aspects of the invention described herein may be applied to any of the particular applications set forth below or for any other types of audio prosthesis.

Embodiments of the present invention provide systems, devices, and methods for a user or wearer of a hearing aid, particularly a deep-in-ear-canal (DIEC) hearing aid, to insert and position the hearing aid in and remove the hearing aid from his or her own ear. As is well known in the art, DIEC hearing aids currently have a residence time of three to four months, which, with improvements in battery life, is likely to be lengthened in the future. Thus, insertion and removal of a DIEC hearing aid is not a frequent occurrence, but the option to do so without the assistance of a healthcare provider is very advantageous for a user in a practical sense. Embodiments of the invention can also be used by a second person, such as a health care provider, a trained health care assistant, or a lay person of normal physical ability with only minimal training and practice, to insert the hearing aid into the ear of a user.

Embodiments of the invention generally allow a DIEC hearing aid to be inserted and/or removed without direct visualization of the ear or the tool by the user when self-inserting the hearing aid. The independence of a reliance on visualizing the process is also a benefit to a second person inserting the hearing aid into the ear of a user, simply because it allows a shift toward reliance on tactile direction of the insertion process.

The insertion apparatus of the invention is also easily handled, allowing a precise insertion of a small device into a small orifice, without the need for a lot of practice or a high level of dexterity.

Further, the insertion apparatus of the invention allows insertion of a DIEC hearing aid without reliance on specialty instruments used by physicians and audiologists that are required by currently available methods of insertion.

As indicated above, in one embodiment, the hearing aid placement apparatus includes a handle, support member, having a hearing aid engagement end that is designed and adapted to engage an in-ear canal hearing aid, and an ear canal ingression stop. The handle ensures that the hearing aid can be consistently inserted and positioned in the same location inside the ear canal and, thereby, ensure consistent sound amplification and comfort.

Before describing the hearing aid placement apparatus in detail, the following brief description of the various anatomical features of the ear is provided to help in the understanding of the various features of the invention.

Referring now to FIG. 1, there is shown an illustration of a human ear 10. As illustrated in FIG. 1, the ear 10 generally comprises three regions: the outer ear 12, middle ear 14 and inner ear 16. The outer ear includes the pinna 18 and the ear canal 20.

The ear canal 20 extends to the eardrum 22, which is disposed at the juncture of the outer ear 12 and middle ear 14. Also disposed in the middle ear 14 are the ossicles 24.

Disposed in the inner ear 16 are the semicircle canals 26, cochlea 28, the Eustachian tube 30 and the auditory nerve 32, which leads to the brain.

Referring now to FIG. 2, a first embodiment of a hearing aid placement apparatus of the invention will be described in detail. As illustrated in FIG. 2, the placement apparatus 40 includes a handle 42, a support member 44, having a hearing aid engagement end 46 that is designed and adapted to engage an in-ear canal hearing aid 100.

The handle 42 is preferably designed and adapted to allow a wearer (or health professional) to hold the handle 42 and insert a hearing aid 100 inside an ear canal 20 (see FIG. 3). According to the invention, the handle 42 can comprise various shapes and materials. In a preferred embodiment, the handle 42 comprises a resilient and compliant material, and is ergonomically designed to be held comfortably by a hand or two or more fingers.

In some embodiments, the handle 42 is designed and adapted to be held between three fingers, such as the thumb, index finger and middle finger. In another embodiment, the handle 42 is designed and adapted to be held between two fingers, such as the index finger and thumb of the operator.

In some embodiments of the invention, the handle 42 and support member 44 are operatively connected to the hearing aid, whereby power and programming signals can be transmitted to the hearing aid via transmission of power and programming signals by the handle 42. In this embodiment, the handle 42 includes charging and signal transmission means. According to the invention, the charging and signal transmission means can comprise wireless charging and signal transmission means.

In some embodiments of the invention, the support member 44 is connected to the handle 42 and preferably allows the ear canal ingression stop 48 (discussed below) to be moved and locked along the longitudinal axis of the support member 44. According to the invention, the handle 42 can be an integral component (or extension) of the support member 44 or a separate component.

According to the invention, the support member 44 can be connected to the handle 42 by various conventional means. In one embodiment, the support member 44 includes a threaded end 45 that is adapted to threadably engage the handle 42. In the noted embodiment, the handle 42 includes a central lumen 43 having corresponding threads that are adapted to cooperate with and, hence, engage the threaded end 45 of the support member 44, whereby the handle 42 can be securely engaged to the support member 44.

In some embodiments of the invention, discussed below, the support member has external threads that extend across the length of the support member 44.

According to the invention, the support member 44 can comprise various shapes and materials. In some embodiments, the support member 44 has a predetermined curved shape to facilitate insertion and proper alignment of a hearing aid 100 in an ear canal 20. In some embodiments, the support member 44 comprises a flexible member, e.g., formed from a flexible polymeric material, to facilitate insertion and proper alignment of a hearing aid 100 in an ear canal 20. In some embodiments, the support member 44 comprises a deformable member to facilitate insertion and proper alignment of a hearing aid 100 in an ear canal 20.

As illustrated in FIG. 2, the placement apparatus 40 further includes an ear canal ingression stop 48. In a preferred embodiment, the ear canal ingression stop 48 has an outer dimension, e.g. diameter of circular shape(s), which prevents a user from advancing a hearing aid too deeply inside an ear canal.

In a preferred embodiment, the ear canal ingression stop 48 is adjustable to facilitate optimum placement of the hearing aid 100 in the ear canal 20 (see FIG. 3).

According to the invention, the ear canal ingression stop 48 can comprise various sizes, shapes and materials to accommodate multiple users, e.g., minors, young and older adults. The size or outer periphery of the stop 48 must, however, be large enough to abate ingress of the stop 48 into the ear canal 20.

In a preferred embodiment, the ear canal ingression stop 48 comprises a pliable polymeric material, such as polyethylene.

In one embodiment, the ear canal ingression stop 48 comprises a round or oval disc, having a threaded central lumen 43 that allows the stop 48 to be screwed onto the support member 44 (which, in this embodiment includes external threads that extend across the length of the support member 44) and translated longitudinally along the support member 44 to adjust the length of the stop 48 and, thereby the engagement end 46 thereof, which extends beyond the stop 48.

According to the invention, the ear canal ingression stop 48 can be secured at the optimum position by various conventional means. In one embodiment, the ear canal ingression stop 48 comprises two threaded discs that can be locked at a desired position on the support member by screwing the two discs against each other. The ear canal ingression stop 48 can also be secured at a desired position on the support member 44 via a conventional adhesive.

As will readily be appreciated by one having ordinary skill in the art, the present invention facilitates optimal positioning of the ear canal ingression stop 48 with respect to the support member 44 and, thereby, the hearing aid 100 by an audiologist or an ENT physician.

According to the invention, various conventional means can be employed to removably engage the support member 44 to a hearing aid 100. In a preferred embodiment, the engagement end 46 of the support member 44 comprises a magnetic end that facilitates engagement of the hearing aid to the support member 44 and, hence, handle 42.

In some embodiments of the invention, wherein the hearing aid 100 includes magnetic control means, such as an on-off switch, engagement and disengagement of the magnetic engagement end 46 of the support member 44 to the hearing aid 100 actuates the hearing aid magnetic control means. In some embodiments, engagement of the magnetic engagement end 46 of the support member 44 to the hearing aid 100 actuates the hearing aid magnetic control means, wherein the hearing aid power is turned off and disengagement of the magnetic engagement end 46 of the support member 44 from the hearing aid 100 powers-up the hearing aid 100.

Referring now to FIG. 4, in some embodiments, the handle 42 includes a mechanical actuator that can be employed to release the magnetic support member end from a hearing aid 100. In this embodiment, the handle 42 includes a magnet support member 52, having a magnet 50 disposed on a first end and a spring stop 51 on the opposing distal end, a mechanical actuator 54 and an actuation spring 56.

As illustrated in FIG. 4, the mechanical actuator 54 is attached to the magnet support member 52, which extends inside the support member 44, and is positioned and supported on the distal end by the spring 56. According to the invention, by sliding the mechanical actuator 54 and, hence, the magnet support member 52 connected thereto back in the direction denoted by arrow A, a user can retract the magnet 50 inside the support member 44, whereby the handle 42 disengages from the hearing aid 100. When the user releases the mechanical actuator 54, the magnet 50 automatically springs back to the distal end of the support member 44.

In one embodiment, the physical contact between the mechanical actuator 54 and the handle 42 prevents the magnet 50 from going past the distal end of the support member 44.

In some embodiments of the invention, the magnet 50 comprises an electromagnet that is energized by an associated switch, which can be employed to turn on and off the magnet 50. In some embodiments, the switch includes a sensor that is designed and positioned to sense when the hearing aid 100 is in a desired position within an ear canal, e.g. when the ear canal ingression stop 48 makes sufficient contact with the pinna 18.

In some embodiments of the invention, wherein the hearing aid 100 includes magnetic control means, such as an on-off switch, engagement and disengagement of the magnet 50 to the hearing aid 100 similarly actuates the hearing aid magnetic control means. In some embodiments, engagement of the magnet 50 to the hearing aid 100 actuates the hearing aid magnetic control means, wherein the hearing aid power is turned off and disengagement of the magnet 50 from the hearing aid 100 powers-up the hearing aid 100.

In some embodiments of the invention, the support member 44 includes mechanical coupling means that is adapted to releasably engage a hearing aid.

In another aspect of the invention, the placement apparatus of the invention is also a package for (or packages with) a DIEC hearing aid, as may be delivered to a health care provider or sold over the counter. In this embodiment, the placement apparatus includes a DIEC hearing aid, such as the DIEC hearing aid disclosed in Applicants' Co-Pending application Ser. No. 12/841,120, loaded within it. A DIEC hearing aid packaged in this manner may be further protected by another layer of conventional packaging.

This packaged form of a product provides several benefits to the user and for the overall distribution of the product into the market. In this packaged form, the DIEC hearing aid is fully protected and tamper proof from the time it leaves the manufacturing facility until the time it is already placed in the ear canal. The placement apparatus/DIEC hearing aid package is also much easier to handle than a naked DIEC hearing aid, and, in fact, a user need not touch or handle the DIEC hearing aid at all, thus keeping it sanitary.

An assisting second person, such as healthcare professional or any capable assistant, also takes advantage of these benefits when inserting a DIEC hearing aid device into the ear canal of a user.

In embodiments of the invention that include a placement apparatus/DIEC hearing aid package, the package and/or the outer surface of the insertion apparatus may be identified with marks or labeling with regard to the specific features of the DIEC device included within.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. An apparatus for insertion, positioning and removal of an in-ear-canal hearing aid, the hearing aid including a first power source and an on-off switch that is in communication with the first power source, the apparatus comprising:
a handle comprising a resilient and compliant material; and
an elongated support member configured to be inserted into an ear canal, said support member comprising a first end that is configured to engage a first end of said handle and a second end that includes magnetic means for removably engaging a first end of said hearing aid,
said magnetic means being configured to actuate said hearing aid on-off switch, wherein when said second magnetic end of said support member is engaged to said first end of said hearing aid, said hearing aid on-off switch transitions to an off position, whereby, no power from said hearing aid power source is transmitted to said hearing aid, and when said second magnetic end of said support member is disengaged from said first end of said hearing aid, said hearing aid on-off switch transitions to an on position, whereby, power from said hearing aid power source is transmitted to said hearing aid,
said support member further comprising memory means programmed and configured for storing programming signals, an interior portion configured to receive said memory means therein, and signal transmission means for transmitting said programming signals from said memory means to said hearing aid when said second magnetic end of said support member is engaged to said hearing aid.

2. The apparatus of claim 1, wherein said apparatus further comprises an adjustable ear canal ingression stop that is configured to limit travel of said support member and, thereby, said hearing aid when engaged thereto in said ear canal.

3. The apparatus of claim 1, wherein said signal transmission means comprises wireless signal transmission means.

4. The apparatus of claim 1, wherein said magnetic means comprises an electromagnet.

5. The apparatus of claim 1, wherein said support member further comprises a second power source and power transmission means for transmitting power from said second power source to and, thereby, charging said hearing aid first power source when said second magnetic end of said support member is engaged to said hearing aid.

4. An apparatus for insertion, positioning and removal of an in-ear-canal hearing aid, the hearing aid including a first power source and an on-off switch that is in communication with the first power source, the apparatus comprising:
a handle comprising a resilient and compliant material;
an elongated support member configured to be inserted into an ear canal, said support member comprising a first end that is configured to engage a first end of said handle and a second end that includes magnetic means for removably engaging a first end of said hearing aid,
said magnetic means being configured to actuate said hearing aid on-off switch, wherein when said second magnetic end of said support member is engaged to said first end of said hearing aid, said hearing aid on-off switch transitions to an off position, whereby, no power from said hearing aid power source is transmitted to said hearing aid, when said second magnetic end of said support member is disengaged from said first end of said hearing aid, said hearing aid on-off switch transitions to an on position, whereby, power from said hearing aid power source is transmitted to said hearing aid,
said support member further comprising memory means programmed and configured for storing programming signals, an interior portion configured to receive said memory means therein, and signal transmission means for transmitting said programming signals from said memory means to said hearing aid when said second magnetic end of said support member is engaged to said hearing aid,
said support member further comprising a second power source and power transmission means for transmitting power from said second power source to and, thereby, charging said hearing aid first power source when said second magnetic end of said support member is engaged to said hearing aid.

5. The apparatus of claim 4, wherein said signal transmission means comprises wireless signal transmission means.
